(19) United States
(12) Patent Application Publication
(10) Pub. No.: US 2013/0322602 A1
(43) Pub. Date: Dec. 5, 2013

(54) INTERNAL SHIELDING X-RAY TUBE

(71) Applicants: Xi Zhang, Ballston Lake, NY (US); Scott Stephen Zelakiewicz, Niskayuna, NY (US); Jeffrey Wayne Eberhard, Albany, NY (US); Fengfeng Tao, Clifton Park, NY (US); Yun Zou, Clifton Park, NY (US)

(72) Inventors: Xi Zhang, Ballston Lake, NY (US); Scott Stephen Zelakiewicz, Niskayuna, NY (US); Jeffrey Wayne Eberhard, Albany, NY (US); Fengfeng Tao, Clifton Park, NY (US); Yun Zou, Clifton Park, NY (US)

(73) Assignee: GENERAL ELECTRIC COMPANY, SCHENECTADY, NY (US)

(21) Appl. No.: 13/485,371

(22) Filed: May 31, 2012

(51) Int. Cl. H01J 35/14

(52) U.S. Cl. 378/138

(57) ABSTRACT

An x-ray tube is presented. One embodiment of the x-ray tube includes a cathode unit configured to emit electrons. The x-ray tube further includes an anode unit positioned to receive the emitted electrons, wherein the anode unit includes a base having a target surface configured to generate x-rays when the emitted electrons impinge on the target surface. Also, the anode unit includes a first shielding unit enclosing the base to attenuate at least a first portion of the generated x-rays within the anode unit.

### BACKGROUND

The disclosure relates generally to an x-ray tube and more specifically to methods and structures for shielding x-rays within the x-ray tube.

Traditional x-ray imaging system includes an x-ray source and a detector array. The x-ray source generates x-rays that pass through an object under scan. These x-rays are attenuated while passing through the object and are received by the detector array. The detector array includes detector elements that produce a separate electrical signal indicative of the attenuated x-rays received by each detector element. Further, the produced electrical signals are transmitted to a data processing system for analysis, which ultimately produces an image.

Typically, the x-ray source includes an x-ray tube that generates x-rays in all directions around a focal spot. A portion of these x-rays may be utilized as intended x-rays for imaging the object that is under scan. However, a large portion of the x-rays are unintended or undesired x-rays that penetrate into other areas of the x-ray tube. Also, these unintended x-rays may escape from the x-ray source causing undesirable health effects to a user in an x-ray environment. In addition, these x-rays may interfere with the intended x-rays causing reduced image quality results. Thus, there is a need to shield these unintended x-rays to safeguard the user from undesirable health hazards and also to improve the quality of the reproduced image.

In a conventional x-ray imaging system, a lead lining is provided on a housing that contains the x-ray tube. The lead lining is used to absorb the unintended x-rays that penetrate through an evacuated enclosure of the x-ray tube. Although the lead lining provides radiation leakage resistance, the housing requires a large surface area to accommodate the lead lining of sufficient thickness. Also, the lead is relatively heavy and substantially adds to the weight of the x-ray tube.

In addition, a large amount of lead is used to cover relatively large portions of the enclosure surface to account for the radially expanding pattern of x-ray emission from the target surface. Indeed, nearly the entire surface area of the housing or the evacuated enclosure is covered by the lead lining to prevent x-ray emission from the tube. This addition of lead lining may in turn increase the cost of the x-ray tube. Also, since the lead lining is provided on the entire surface area of the housing, the time and labor for manufacturing each x-ray tube is substantially increased.

Hence, there is a need for an improved method and structure for shielding the x-rays within the x-ray tube. Also, there is need to substantially reduce the weight of the x-ray tube.

### BRIEF DESCRIPTION

Briefly in accordance with one aspect of the present disclosure, an x-ray tube is presented. The x-ray tube includes a cathode unit configured to emit electrons. The x-ray tube further includes an anode unit positioned to receive the emitted electrons, wherein the anode unit includes a base having a target surface configured to generate x-rays when the emitted electrons impinge on the target surface. Also, the anode unit includes a first shielding unit enclosing the base to attenuate at least a first portion of the generated x-rays within the anode unit.

In accordance with a further aspect of the present disclosure, a method for shielding the x-rays within the x-ray tube is presented. The method includes emitting, by a cathode unit, electrons toward an anode unit. The method further includes generating x-rays when the emitted electrons impinge on a target surface of the anode unit. Also, the method includes attenuating at least a first portion of the generated x-rays within the anode unit by enclosing at least the target surface of the anode unit with a first shielding unit.

In accordance with another aspect of the present disclosure, an x-ray tube is presented. The x-ray tube includes a cathode unit comprising an electron source configured to emit electrons. Further, the x-ray tube includes an anode unit positioned to receive the emitted electrons, and configured to generate x-rays when the emitted electrons impinge on the anode unit. Also, the x-ray tube includes a first shielding unit enclosing the anode unit to attenuate at least a first portion of the generated x-rays within the anode unit. In addition, the x-ray tube includes a second shielding unit disposed at the cathode unit, and configured to attenuate at least the first portion of the generated x-rays exited through a first window of the first shielding unit.

### DRAWINGS

These and other features, aspects, and advantages of the present invention will become better understood when the following detailed description is read with reference to the accompanying drawings in which like characters represent like parts throughout the drawings, wherein:

FIG. 1 is a cross sectional view of an x-ray tube, in accordance with one embodiment of the present disclosure;

FIG. 2 is a cross sectional view of the x-ray tube, in accordance with another embodiment of the present disclosure; and

FIG. 3 is a flow chart illustrating a method for shielding the x-rays within the x-ray tube, in accordance with aspects of the present disclosure.

### DETAILED DESCRIPTION

As will be described in detail hereinafter, various embodiments of an exemplary structures and methods for shielding x-rays within the x-ray tube are presented. By employing the methods and the various embodiments of the x-ray shielding structures described hereinafter, the weight of the x-ray tube is substantially reduced. Also, the cost and time for manufacturing the x-ray tube is substantially reduced.

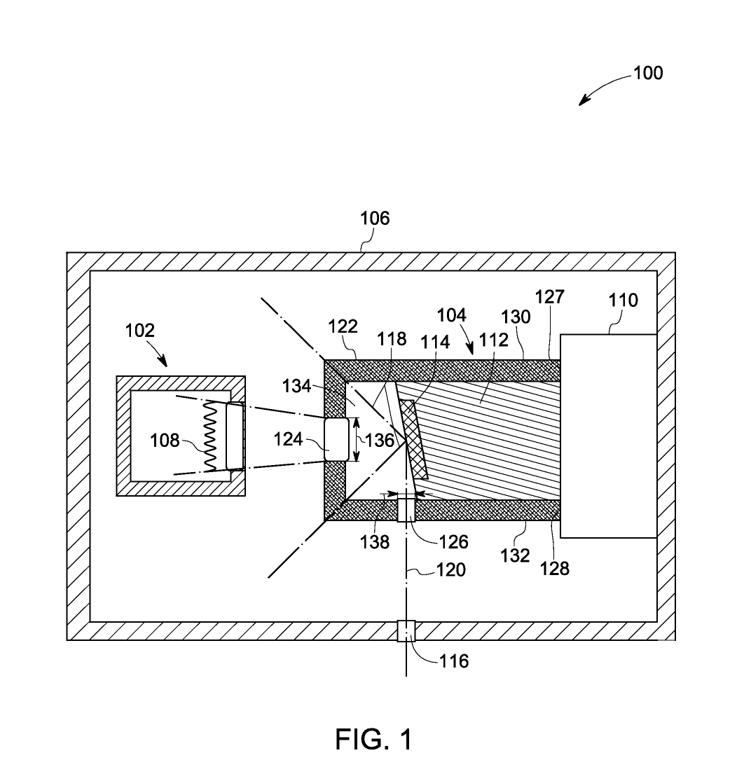

Referring to FIG. 1, a cross sectional view of an x-ray tube 100, in accordance with one embodiment of the present disclosure, is depicted. The x-ray tube 100 includes a cathode unit 102 and an anode unit 104 that are disposed within an evacuated enclosure 106. The evacuated enclosure 106 may be a vacuum chamber that is positioned within a housing (not shown) of the x-ray tube 100. The cathode unit 102 includes an electron source 108 for emitting electrons towards the anode unit 104. Particularly, an electric current is applied to the electron source 108, such as a filament, which causes electrons to be produced by thermionic emission. The electric current may be applied by a high voltage connector (not shown) that is electrically coupled between a voltage source (not shown) and the cathode unit 102.

Further, the anode unit 104 includes a support platform 110 and a base 112 having a target surface 114. The base 112 is coupled to the support platform 110 and the target surface 114 is disposed atop of the base 112. Also, the target surface 114 is positioned in the direction of emitted electrons to receive the electrons from the cathode unit 102. Particularly, in the embodiment of FIG. 1, a copper base with a target surface having materials with high atomic numbers (“Z” numbers), such as rhodium, palladium, and/or tungsten, is employed in the anode unit 104.

During operation, the cathode unit 102 generates electrons that are accelerated towards the target surface 114 of the anode unit 104 by applying a high voltage potential between the cathode unit 102 and the anode unit 104. These electrons impinge upon the target surface 114 at a focal spot and release kinetic energy as electromagnetic radiation of very high frequency, i.e., x-rays. Particularly, the electrons are rapidly decelerated upon striking the target surface 114, and in the process, the x-rays are generated therefrom. These x-rays emanate in all directions from the target surface 114. A portion of these x-rays does indeed pass through an outlet 116 of the evacuated enclosure 106 to exit the x-ray tube and be utilized to interact in or on a material sample, patient, or other object. In one embodiment, the target surface 114 may angled towards the outlet 116 of the evacuated enclosure 106 to maximize the number of x-rays produced at the target surface 114 that can exit the x-ray tube 100.

However, the remaining portions of the x-rays that do not pass through the outlet 116 of the evacuated enclosure 106 may penetrate through other areas of the evacuated enclosure 106 and may escape from the x-ray tube 100. It is to be noted that the portion of the x-rays that do not pass through the outlet of the evacuated enclosure is referred to as a first portion 118 of the x-rays or the unintended x-rays 118. Similarly, the portion of the x-rays that pass through the outlet of the evacuated enclosure is referred to as a second portion 120 of the x-rays or the intended x-rays 120. Further, the first portion 118 of the x-rays may scatter at a plurality of angles from the target surface 114. Also, the first portion 118 of the x-rays that penetrate through the evacuated enclosure 106 may represent a significant source of x-ray contamination to the x-ray tube 100 or device surroundings. For instance, users of the x-ray tube 100 may receive relatively high doses of x-ray radiation, which may result in adverse health effects.

To address these shortcomings or problems, a shielding unit 122 is employed within the evacuated enclosure 106 to resist leakage of x-rays from the x-ray tube 100. Particularly, a first shielding unit 122 is disposed at the anode unit 104 to shield the first portion 118 of the x-rays within the anode unit 104. More specifically, the first shielding unit 122 is used to enclose the anode unit 104 so that the first portion 118 of the x-rays is attenuated within the anode unit 104. In one embodiment, the first shielding unit 122 may include a tungsten layer that is placed around the base 112 of the anode unit 104. Since the first portion 118 of the x-rays is shielded within the evacuated enclosure 106, specifically at the focal spot, the surface area for disposing the shielding unit 122 is substantially reduced. Also, as the surface area for disposing the shielding unit 122 is reduced, the size of the shielding unit 122 is reduced, which in turn reduces the weight and cost of the x-ray tube 100. In one example, the first shielding unit 122 may have a thickness in a range from about 1 mm to about 10 mm and a diameter in a range from about 20 mm to about 40 mm. It is to be noted that the thickness and the diameter of the shielding unit may vary depending upon the voltage (HV) and current (mAs) provided to the x-ray tube 100. Also, the first shielding unit 122 may have a length in a range from about 10 mm to about 30 mm. Further, the first shielding unit 122 includes a tungsten copper alloy material for attenuating the first portion 118 of the x-rays. The tungsten copper alloy may be easily molded to a desired shape. Also, the tungsten copper alloy may be easily brazed to the copper base 112 of the anode unit 104.

In the embodiment of FIG. 1, the first shielding unit 122 is a c-shaped structure with two apertures known as a first window 124 and a second window 126. The first window 124 is aligned along a focal path of the emitted electrons. Particularly, the first window 124 is positioned to allow the emitted electrons to enter the anode unit 104 and impinge on the target surface 114.

In a similar manner, the second window 126 is aligned along the outlet 116 of the evacuated enclosure 106 to exit the intended or second portion 120 of the x-rays from the anode unit 104. The length 138 of the second window 126 may be in a range from about 5mm to about 25 mm. Further, the exited second portion of x-rays may be utilized to scan the object. Also, the c-shaped structure may provide a vacuum passage/gap 134 at the target surface 114 of the anode unit 104 to allow the electrons to impinge on the target surface 114 and generate the x-rays. Particularly, the vacuum passage/gap 134 is provided between the windows 124, 126 of the first shielding unit 122 and the target surface 114 of the anode unit 104.

In addition, open ends 127, 128 of the c-shaped structure 122 are rigidly coupled to the support platform 110 of the anode unit 104. Also, the walls 130, 132 of the c-shaped structure may be integrated with the base 112 of the anode unit 104, as depicted in FIG. 1. In one embodiment, a portion of the walls 130, 132 of the c-shaped structure that are disposed adjacent to the surface of the base 112 may be either wielded or screwed to the base 112 of the anode unit 104. Thus, the first shielding unit 122 is tightly coupled to the base 112 of the anode unit 104 and provides no space or opening for the first portion 118 of the x-rays to escape from the anode unit 104. Since the first shielding unit 122 is tightly coupled to the base 112 of the anode unit 104, the unintended x-rays or the first portion 118 of the x-rays scattering in one or more directions is attenuated within the anode unit 104. Particularly, the first shielding unit 122 absorbs the first portion 118 of the x-rays that is scattering from the target surface 114 of the anode unit 104.

Thus, by employing the shielding unit 122 within the evacuated enclosure 106, the radiation of unintended x-rays surrounding the x-ray tube 100 is substantially reduced. Also, as the shielding unit 122 is provided within the evacuated enclosure 106, the surface area utilized to shield the x-rays is substantially minimized, which in turn reduces the weight of the x-ray tube or device 100.

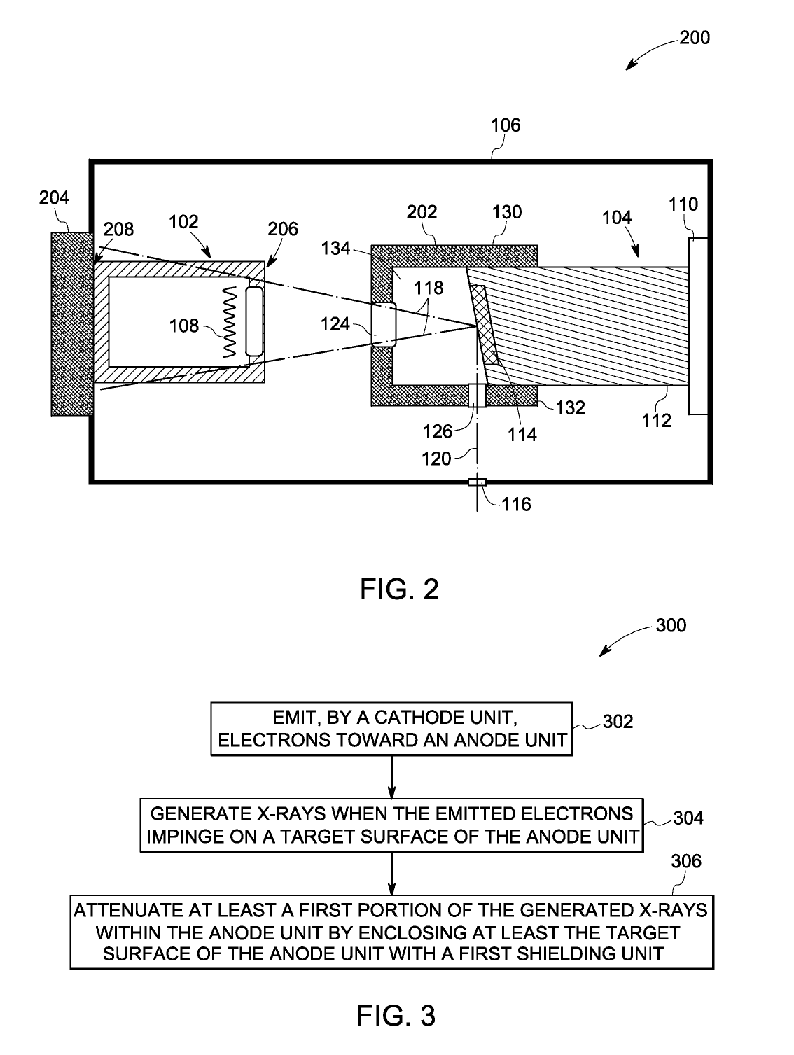

FIG. 2 is a cross sectional view of an x-ray tube 200, in accordance with another embodiment of the present disclosure. The x-ray tube 200 is similar to the x-ray tube 100 of FIG. 1 except that the anode unit 104 is enclosed by a first shielding unit 202 that is different in structure from the structure of the first shielding unit 122 of FIG. 1. Also, the x-ray tube 200 of FIG. 2 is shown with another shielding unit known as a second shielding unit 204. It is to be noted that the function of the first shielding unit 202 is similar to the function of the first shielding unit 122 of FIG. 1. However, the structure of the first shielding unit 202 is modified to minimize the length of the first shielding unit 202. Particularly, the length of the walls 130, 132 of the first shielding unit is reduced to a top portion of the base 112, as depicted in FIG. 2. Also, the walls 130, 132 that are disposed adjacent to the surface of the base 112 are integrated with the base 112 of the anode unit 104. In one example, the walls 130, 132 may be welded or screwed to the base 112 of the anode unit 104.

Further, the second shielding unit 204 is disposed outside the evacuated enclosure 106, as depicted in FIG. 2, to shield the first portion 118 of the x-rays that passes through the first window 124 of the first shielding unit 202. Particularly, the first window 124 of the first shielding unit 202 is used to allow the emitted electrons to impinge on the target surface 114 of the anode unit 104. However, while the electrons enter the anode unit 104, the first portion 118 of the x-rays may backscatter from the target surface 114 and may exit the anode unit 104 via the first window 124 of the shielding unit 202. To attenuate or shield this exited first portion 118 of the x-rays, the second shielding unit 204 is positioned outside the evacuated enclosure 106. The second shielding unit 204 may include materials, such as lead, copper, tungsten, molybdenum, rhodium, palladium and/or other polymer-metal composite. It is to be noted that the thickness of the second shielding unit 204 may vary depending on the type of material used in the second shielding unit 204. In one embodiment, the second shielding unit 204 includes a tungsten copper alloy material for attenuating the first portion 118 of the x-rays.

Moreover, the second shielding unit 204 is positioned outside the evacuated enclosure 106 facing the second end 208 of the cathode unit 102. Particularly, the second shielding unit 204 may be positioned to face the first window 124 to collect the unintended x-rays generated at the anode unit 104. In one embodiment, the second shielding unit 204 may be a disc like structure that is rigidly coupled to an outer surface of the evacuated enclosure 106 at the second end 208 of the cathode unit 102, as depicted in FIG. 2. In another embodiment, the second shielding unit 204 may be coupled to an inner surface of the evacuated enclosure 106 at the second end 208 of the cathode unit 102. Further, since the second shielding unit 204 is positioned to face the first window 124 of the first shielding unit 202, the first portion 118 of the x-rays that pass through the first widow 124 is absorbed or attenuated by the second shielding unit 204. Thus, by employing the second shielding unit 204 along with the first shielding unit 202 in the x-ray tube 200, the unintended x-rays or the first portion 118 of the x-rays may be substantially attenuated within the x-ray tube 200.

Referring to FIG. 3, a flow chart 300 illustrating a method for shielding the x-rays within the x-ray tube, in accordance with aspects of the present disclosure, is depicted. For ease of understanding of the present disclosure, the method is described with reference to the components of FIGS. 1 and 2. The method begins at step 302, where the electrons are emitted toward the anode unit 104. To that end, the cathode unit 102 is configured to emit the electrons toward the anode unit 104. Particularly, an electric current is applied to the electron source, such as a filament 108, which causes the electrons to be produced by thermionic emission.

Additionally, at step 304, x-rays are generated at the anode unit 104 when the emitted electrons impinge on a target surface 114 of the anode unit 104. Particularly, the electrons are accelerated towards the target surface 114 of the anode unit 104 by applying a high voltage potential between the cathode unit 102 and the anode unit 104. These electrons impinge upon the target surface 114 at a focal spot and release kinetic energy as electromagnetic radiation of very high frequency, i.e., x-rays. These x-rays may include a first portion 118 of the x-rays and a second portion 120 of the x-rays. The first portion 118 of the x-rays emanate in all directions from the target surface 114. Particularly, the first portion 118 of the x-rays may penetrate through other areas of the evacuated enclosure 106 and may escape from the x-ray tube 100. On the other hand, the second portion 120 of the x-rays may pass through an outlet 116 of the evacuated enclosure 106 to exit the x-ray tube 100 and may be utilized to scan the object.

Further, at step 306, the first portion of the generated x-rays may be attenuated within the anode unit 104 by enclosing at least the target surface 114 of the anode unit 104. To that end, the first shielding unit 122 is enclosed within the evacuated enclosure 106, particularly over the target surface 114 of the anode unit 104, to absorb or attenuate the first portion 118 of the x-rays that scatter at one or more angles from the target surface 114. In addition to the first shielding unit, the second shielding unit 204 may be disposed at the cathode unit 102 to absorb or attenuate the first portion 118 of the x-rays that passes through the first window 124 of the first shielding unit 122. Thus, by employing the shielding units 122 and 204 within the evacuated enclosure 106, the radiation of unintended x-rays surrounding the x-ray tube 100 is substantially reduced. Also, as the shielding units 122 and 204 are provided within the evacuated enclosure 106, the surface area utilized to shield the x-rays is substantially minimized, which in turn reduces the weight of the x-ray tube 100 and also cost and time for manufacturing the x-ray tube 100.

The various embodiments of the method and the structures of the x-ray tube aid in shielding the unintended x-rays within the x-ray tube. Also, as the shielding unit is disposed within the evacuated enclosure, the weight of the x-ray tube is substantially reduced. Also, by disposing the shielding unit within the evacuated enclosure, the surface area that is used for shielding the x-rays is reduced, which in turn reduces the cost and time for manufacturing the x-ray tube.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An x-ray tube comprising:
a cathode unit configured to emit electrons;
an anode unit positioned to receive the emitted electrons, wherein the anode unit comprises:
a base having a target surface configured to generate x-rays when the emitted electrons impinge on the target surface; and
a first shielding unit enclosing the base to attenuate at least a first portion of the generated x-rays within the anode unit.

2. The x-ray tube of claim 1 further comprising a vacuum chamber enclosing the cathode unit and the anode unit.

3. The x-ray tube of claim 1, wherein the first shielding unit comprises:
a first window configured to allow the electrons to impinge on the target surface; and
a second window configured to exit a second portion of the generated x-rays from the anode unit.

4. The x-ray tube of claim 3, wherein the first window is positioned along a focal path of the electrons to allow the electrons to impinge on the target surface.

5. The x-ray tube of claim 3, wherein the cathode unit comprises:
an electron source disposed at a first end of the cathode unit and configured to generate the electrons; and
a second shielding unit disposed at a second end of the cathode unit and configured to shield the first portion of the x-rays exiting through the first window of the anode unit.

6. The x-ray tube of claim 5, wherein the second shielding unit comprises a tungsten copper alloy material for attenuating the first portion of the x-rays exiting from the anode unit.

7. The x-ray tube of claim 1, wherein the first portion of the x-rays scatter at a plurality of angles with respect to the target surface.

8. The x-ray tube of claim 7, wherein the first shielding unit is enclosed over a focal spot on the target surface to attenuate the first portion of the x-rays scattering at the plurality of angles within the anode unit.

9. The x-ray tube of claim 1, wherein at least a portion of the first shielding unit is integrated with the base of the anode unit.

10. The x-ray tube of claim 1, wherein the first shielding unit comprises a tungsten copper alloy material for attenuating the first portion of the x-rays.

11. A method comprising:
emitting, by a cathode unit, electrons toward an anode unit;
generating x-rays when the emitted electrons impinge on a target surface of the anode unit; and
attenuating at least a first portion of the generated x-rays within the anode unit by enclosing at least the target surface of the anode unit with a first shielding unit.

12. The method of claim 11, wherein generating the x-rays when the emitted electrons impinge on a target surface comprises allowing the emitted electrons to impinge on the target surface through a first window of the first shielding unit.

13. The method of claim 12, wherein allowing the electrons to impinge on the target surface comprises exiting the first portion of the generated x-rays from the anode unit through the first window while allowing the electrons to impinge on the target surface.

14. The method of claim 13, wherein exiting the first portion of the generated x-rays comprises disposing a second shielding unit at the cathode unit to attenuate the exited first portion of the x-rays.

15. The method of claim 11, wherein attenuating at least a first portion of the generated x-rays comprises exiting a second portion of the generated x-rays from the anode unit through a second window of the first shielding unit.

16. The method of claim 15, wherein exiting a second portion of the generated x-rays comprises directing the second portion of the generated x-rays towards an object under scan.

17. The method of claim 11, wherein attenuating the first portion of the generated x-rays comprises shrouding the first shielding unit over a focal spot on the target surface to attenuate the first portion of the x-rays.

18. The method of claim 11, wherein enclosing at least the target surface of the anode unit with a first shielding unit comprises integrating the first shielding unit with a base of the anode unit to attenuate the first portion of the generated x-rays.

19. An x-ray tube comprising:
a cathode unit comprising an electron source configured to emit electrons;
an anode unit positioned to receive the emitted electrons, and configured to generate x-rays when the emitted electrons impinge on the anode unit;
a first shielding unit enclosing the anode unit to attenuate at least a first portion of the generated x-rays within the anode unit; and
a second shielding unit disposed at the cathode unit, and configured to attenuate at least the first portion of the generated x-rays exited through a first window of the first shielding unit.
